(19) United States
(12) Patent Application Publication
(10) Pub. No.: US 2005/0130472 A1
(43) Pub. Date: Jun. 16, 2005

(54) Electrical connector having pick-up cap

(76) Inventor: Sung-Pei Hou, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/993,663

(22) Filed: Nov. 19, 2004

(30) Foreign Application Priority Data
Nov. 21, 2003 (TW) 92220598

(51) Int. Cl. H01R 13/44

(52) U.S. Cl. 439/135

(57) ABSTRACT

An electrical connector (1) includes an insulative housing (20), a number of terminals (21) received in the insulative housing, and a pick-up cap (3) received in the insulative housing. The insulative includes two opposite lateral walls (201), each lateral wall defines a gap (2051) thereon. The pick-up cap comprises a retaining portion (32) completely received in the gap of the lateral wall of the insulative housing.

### BACKGROUND OF THE INVENTION

1. Field of the Invention

The present invention generally relates to an electrical connector, and particular to an electrical connector having a pick-up cap.

2. Description of Prior Arts

Generally, when soldering an electrical connector to a printed circuit board (PCB), a pick-up cap is needed to mount to the electrical connector. Thus, a suction nozzle of a suction apparatus can engage with the pick-up cap and place the electrical connector on a predetermined place of the PCB. FIG. 4 and FIG. 5 show an electrical connector 9 having a pick-up cap. The electrical connector 9 comprises an insulative housing 90, a pick-up cap 91 locking on the insulative housing 90, and a plurality of terminals 92 received in the insulative housing 90. The insulative housing 90 comprises a central area 902 and lateral walls 903 higher than the central area 902. The central area 902 has a plurality of terminal channels 9020 for retaining the terminals 92 therein. The opposite lateral walls 903 each has a locking member 9030 on the outer face thereof. The pick-up cap 91 comprises a holding portion 910, a connecting portion 911 extending from the holding portion 911, and a pair of retaining portions 912 extending downwardly from the opposite sides of the connecting portion 911. The pick-up cap 91 straddles the insulative housing 90 with the retaining portion 912 of the pick-up cap 91 engaging with the locking member 9030 of the insulative housing 90. Whereby, the pick-up cap 91 is retained to the insulative housing 90. However, the dimension both in the vertical direction and the longitude direction of the pick-up cap 91 is beyond those of the insulative housing 90, respectively. As a result, the size of the whole electrical connector is increased. Obviously, this electrical connector 9 increases the cost of the package and occupies a relatively large space on the PCB.

For solving above problem, a new design is provided in FIG. 6. An electrical connector 8 comprises an insulative housing 80 and a film 81 attaching closely to the insulative housing 80. The film 81 made from viscid plastic material is very filmy and has a smooth face. However, when the suction nozzle sucks and presses the film of the electrical connector 8, the film 81 bends downwardly because of filmy and soft material. Thus, the airproof capability is decreased to cause the suction nozzle not suck the electrical connector 8 firmly.

Hence, it is desirable to have an improved electrical connector to overcome the above-mentioned disadvantages of the prior art.

### BRIEF SUMMARY OF THE INVENTION

Accordingly, it is an object of the present invention to provide an electrical connector with decreased size and having a pick-up cap.

In order to achieve the above-mentioned objects, an electrical connector comprises an insulative housing, a plurality of terminals received in the insulative housing, and a pick-up cap. The insulative housing comprises a central area and two opposite lateral walls surrounding the central area, each lateral wall defines a gap thereon. The pick-up cap comprises a holding portion, a connecting portion extending from the holding portion, and a retaining portion extending from the connecting portion vertically. The locking portion completely received in the gap of the lateral wall of the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded view of an electrical connector in accordance with the present invention;

FIG. 2 is a perspective view of the electrical connector shown in FIG. 1;

FIG. 3 is a cross-sectional view taken along line 3-3 of FIG. 2;

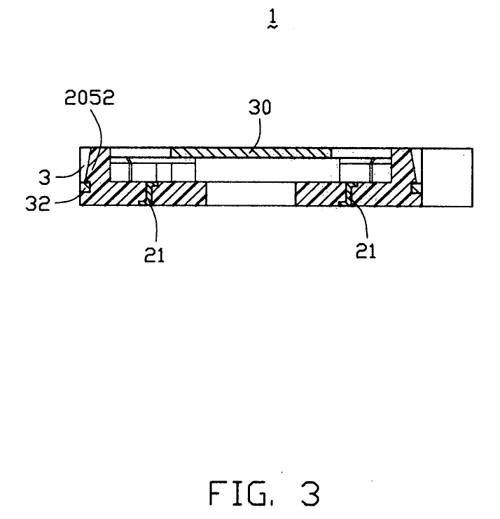

FIG. 4 is an exploded view of a conventional electrical connector;

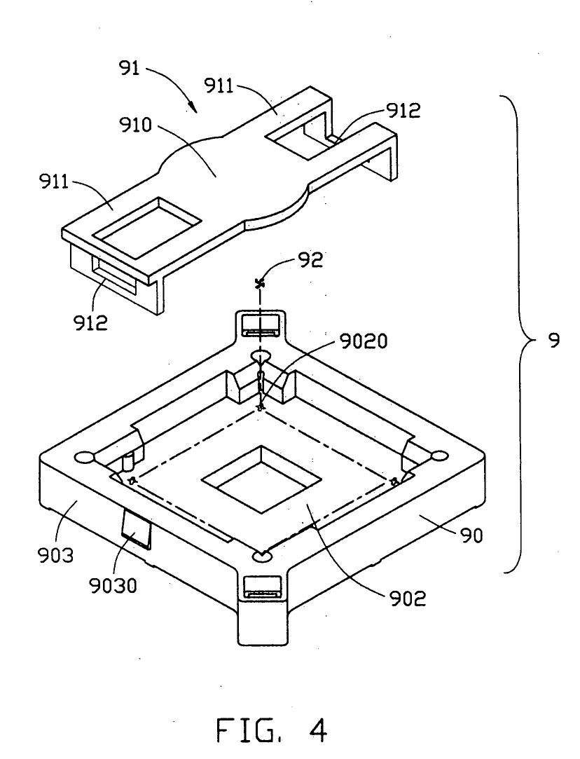

FIG. 5 is a perspective view of the electrical connector shown in FIG. 4; and

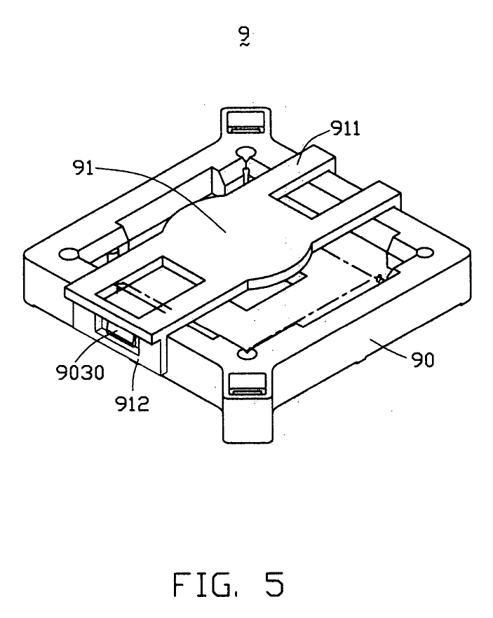

FIG. 6 is a perspective view of another conventional electrical connector.

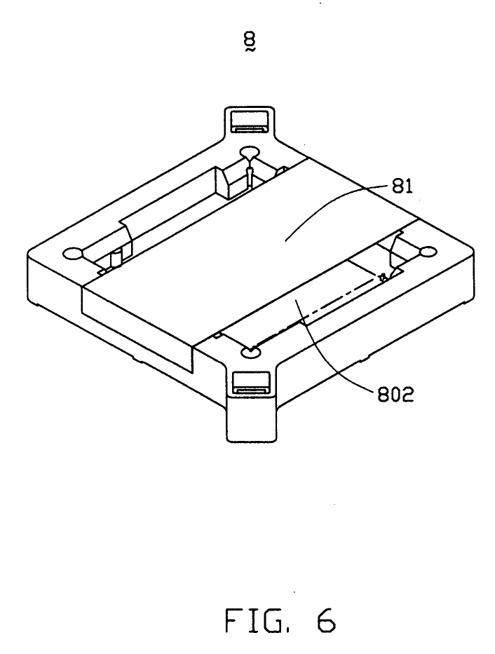

### DETAILED DESCRIPTION OF THE PREFERRED EMBODIMENT

Reference will now be made to the drawing figures to describe the present invention in detail.

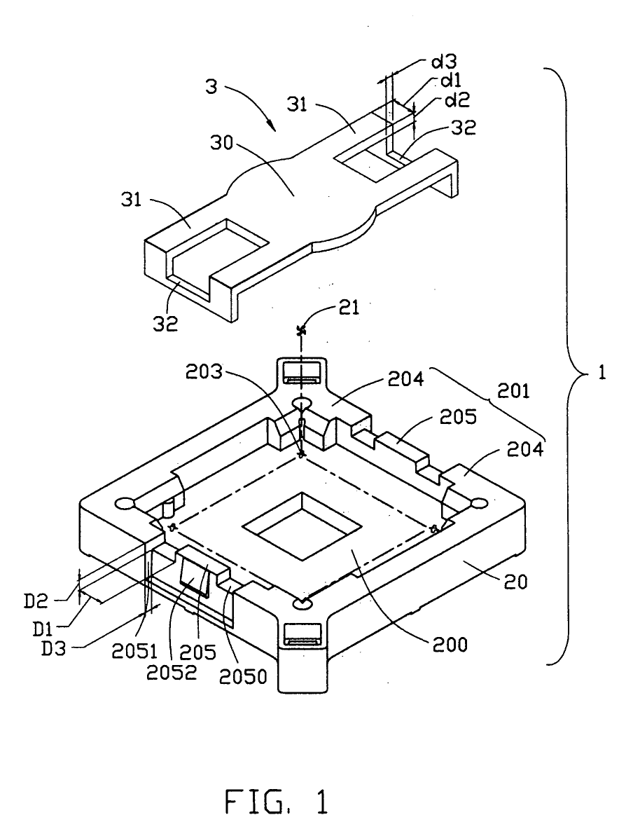

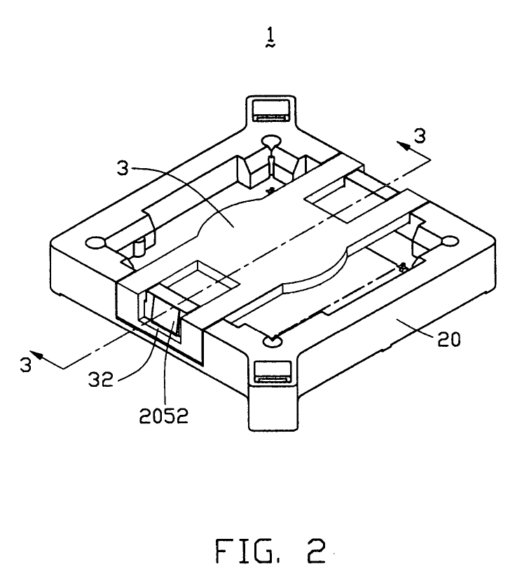

With reference to FIG. 1 and FIG. 2, an electrical connector 1 mounted on a PCB comprises an inslulative housing 20, a plurality of terminals 21 received in the insulative housing 20, and a pick-up cap 3 locking with the insulative housing 20.

The insulative housing 20 comprises a central area 200, two pairs of lateral walls 201 surrounding the central area 200. The central area 200 has a plurality of terminal channels 203 extending from a top surface to a bottom surface thereof for receiving the terminals 21 therein. A pair of lateral walls 201, each has base portion 204 and a locking portion 205 at the center of the base portion 204. A gap 2051 is defined between the base portion 204 and the locking portion 205. The locking portion 205 defines two slits 2050 spaced with each other and an inclined block 2052 extending from the locking portion 205.

The pick-up cap 3 is retained on the insulative housing 20, and comprises a holding portion 30 extending along a first direction with a smooth surface, a connecting portion 31 extending from opposite sides of the holding portion 30 along the first direction, and a retaining portion 32 extending from the connecting portion 31 vertically in a second direction. A third direction is perpendicular to both first direction and second direction. A dimension d1 of the connecting portion 31 along the second direction is equal to a dimension D1 of the slit 2050 along the third direction. A dimension d2 of the connecting portion 31 is not more than a dimension D2 of the slit 2050 along the second direction. A dimension d3 of the retaining portion 32 is not more than a dimension D3 of the gap 2051 along the first direction.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector comprising:
an insulative housing comprising a pair of lateral walls, each lateral wall defining a gap thereon;
a plurality of terminals received in the insulative housing; and
a pick-up cap comprising a retaining portion completely received in the gap of the insulative housing.

2. The electrical connector as described in claim 1, wherein each lateral wall comprises a base portion and a locking portion defined in the center of the lateral wall, the gap is defined between the base portion and the locking portion of the insulative housing.

3. The electrical connector as claimed in claim 2, wherein the pick-up cap further comprises a holding portion and a connecting portion extending from the holding portion, the retaining portion of the pick-up cap extends from the connecting portion corresponding to the locking portion.

4. The electrical connector as claimed in claim 3, wherein the locking portion of the insulative housing comprises a pair of slits.

5. The electrical connector as claimed in claim 4, wherein the pick-up cap comprises a holding portion extending along the first direction, a connecting portion extending from the holding portion extending along the first direction, the locking portion extends from the locking portion extends along the second direction, a third direction is perpendicular to both the first direction and the second direction.

6. The electrical connector as claimed in claim 5, wherein the thickness of the retaining portion of the pick-up cap is smaller than the thickness of the gap between the base portion and the locking portion in the first direction.

7. The electrical connector as claimed in claim 5, wherein the thickness of the retaining portion is equal to the thickness of the gap between the base portion and the locking portion in the first direction.

8. The electrical connector as claimed in claim 5, wherein the thickness of the connecting portion is smaller than the depth of the slit of the locking portion in the second direction.

9. The electrical connector as claimed in claim 5, wherein the thickness of the connecting portion is equal to the depth of the slit of the locking portion in the second direction.

10. An electrical connector comprises:
an insulative housing comprises a pair of lateral walls, each lateral wall comprising a base portion and a locking portion formed in the middle of the lateral wall;
a plurality of terminals retained in the insulative housing;
a pick-up cap comprising a holding portion having a smooth surface and a retaining portion corresponding to the locking portion of the lateral wall, the pick-up cap being completely limited in the insulative housing.

11. The electrical connector as claimed in claim 10, wherein the base portion and the locking portion define a gap therebetween, the retaining portion of the pick-up cap is completely received in the gap.

12. The electrical connector as claimed in claim 11, wherein the locking portion of the insulative housing defines a pair of slit.

13. The electrical connector as claimed in claim 11, wherein the pick-up cap comprises a holding portion extending in a longitudinal direction.

14. The electrical connector as claimed in claim 13, wherein the thickness of the retaining portion of the pick-up cap is smaller than the thickness of the gap between the base portion and the locking portion in the longitudinal direction.

15. The electrical connector as claimed in claim 13, wherein the thickness of the retaining portion of the pick-up cap is equal to the thickness of the gap between the base portion and the retaining portion in the longitudinal direction.

16. An electrical connector assembly comprising:
an insulative housing including a base and at least two opposite side walls commonly defining an upward cavity to receive an electronic package;
a plurality of contacts disposed in the base and in communication with the upward cavity;
a pair of locking portion formed on said two opposite side walls, a gap formed in a lateral exterior face of a base portion of each of said side walls and beside the corresponding locking portion; and
a pick up cap detachably assembled to the housing and defining a U-shaped configuration including a horizontal holding portion and two vertical retaining portions; wherein
the two retaining portions are received in the corresponding gaps, respectively.

17. The assembly as claimed in claim 16, wherein said retaining portion is completely embedded within the corresponding gap so as not to protrude out of the lateral exterior face of the base portion of the corresponding side wall.

18. The assembly as claimed in claim 16, wherein a pair of slits are formed in an upward exterior face of the base portion beside the locking portion, and the pick up cap includes a pair of horizontal connection portions received in the corresponding slits, respectively, for restraining movement of the pick up cap relative to the housing in a horizontal direction along said side wall.

19. The assembly as claimed in claim 16, wherein the locking portion includes an inclined block engaged with the corresponding retaining portion for restraining movement of the pick up cap relative to the housing in an upward direction.
